(19) United States
(12) Patent Application Publication
(10) Pub. No.: US 2009/0011693 A1
(43) Pub. Date: Jan. 8, 2009

(54) STRUCTURE OF CUTTING TIP AND SAW BLADE INCLUDING THE STRUCTURE

(76) Inventor: Chang Shin Cho, Incheon City (KR)

Correspondence Address: ROTHWELL, FIGG, ERNST & MANBECK, P.C., 1425 K STREET, N.W., SUITE 800, WASHINGTON, DC, 20005, US

(21) Appl. No.: 11/913,126

(22) PCT Filed: May 2, 2006
(86) PCT No.: PCT/KR06/01649

§ 371 Date: Oct. 30, 2007

(30) Foreign Application Priority Data
May 3, 2005 (KR) 10-2005-0037184
Apr. 26, 2006 (KR) 10-2006-0037731

(51) Int. Cl. B23D 61/02; B24D 5/12

(52) U.S. Cl. 451/488; 451/548; 125/15

(57) ABSTRACT

Disclosed is a saw blade capable of rapid cutting for various objects, such as jewelry, ferrite materials, stone, metallic materials, or ceramic tiles. The shape of the saw blade is modified such that performance and life time of the saw blade are improved. And also the manufacturing process for the saw blade is simplified, thereby reducing the manufacturing cost for the saw blade. The cutting tip is formed at upper and lower surfaces thereof with a mesh pattern, thereby enhancing the cutting performance by 30% as compared with that of a conventional cutting tip. The cutting tip represents superior cooling efficiency so that body of the saw blade is not broken during the cutting process, thereby ensuring safety of a worker and expanding the life time of the saw blade. The life time of the cutting tip is controlled by adjusting the content of diamond powder contained in the segment on the basis of hardness of a metal bond, regardless of the chemical composition and composition ratio of the metal bond contained in the segment. The cutting tip is suitable for various objects to be cut and the saw blade having the cutting tip is easily fabricated according to applications thereof, so that the manufacturing process for the saw blade is simplified and the manufacturing cost for the saw blade is significantly reduced.

### TECHNICAL FIELD

The present invention relates to a saw blade capable of rapid cutting for various objects, such as jewelry, ferrite materials, stone, metallic materials or ceramic tiles. More particularly, the present invention relates to a structure of a cutting tip and a saw blade having the tip. The shape of the tip and blade are modified such that the cutting performance and the life time of the saw blade can be improved. Further the manufacturing process for the saw blade can be simplified and also reduced the manufacturing cost for the saw blade.

### BACKGROUND ART

As generally known in the art, a saw is equipped with a plurality of saw teeth, which are continuously aligned so as to cut various materials, such as wood, synthetic resin, or metals. Such a saw is classified into an automatic saw and a manual saw according to the operational manner thereof. The manual saw operates at a low speed and is mainly used to cut materials having relatively low hardness, so that saw teeth of the manual saw are less damaged than those of the automatic saw during the operation. The saw teeth of the automatic saw may collide to objects being cut with very high speed that the saw teeth of the automatic saw are easily broken and worn out. For this reason, the cutting performance of the automatic saw may be significantly lowered as it being used continuously. Recently, in order to solve the above problem, there has been suggested an automatic saw having a cutting tip in the form of segments including a hard metal or diamond powder.

FIGS. 1 and 2 are front views illustrating a conventional circular saw blade 9. The circular saw blade 9 is installed in a cutting device (not shown), that is, a saw that includes a driving unit and a control unit for cutting an object, such as stone or metallic materials. The circular saw blade 9 includes a disc plate 10 formed at the center portion thereof with a shaft hole 11 to be coupled with a rotating shaft of a motor, which is the driving unit of the cutting device (not shown), and a cutting tip 20 in the form of segments, which are aligned at an outer peripheral portion of the disc plate 10 at a uniform pitch so as to cut an object made from a hard material.

The conventional circular saw blade includes a disc-shaped steel shank having a shaft hole to be coupled with a driving shaft, and a cutting tip in the form of segments, which are aligned at an outer peripheral portion of the steel shaft with a predetermined width and consist of a metal bond and diamond powder. At this time, a thickness of the cutting tip must be thicker than that of the steel shank such that the cutting tip can be easily introduced into the object to be cut. The high speed rotating saw blade approaches to the object to be cut while forming a right angle with respect to a cutting surface of the object.

However, according to the conventional circular saw blade having the above structure, the strength of the steel shank may be degraded due to synergistic action like heat generations occurred from the cutting tip itself and from friction of the steel shank during the cutting process. In addition, as the cutting process continues, vibration may be seriously generated from the steel shank due to heat and friction applied to the steel shank, so that the objects cannot be precisely cut.

Such frictional heat and overload may damage the expensive saw blade by shortening the life time of the saw blade. In addition, the motor having the rotating shaft coupled with the saw blade is also seriously damaged and worn, so that the life time of the cutting device may be significantly shortened, thereby causing waste in terms of cost and degrading the working efficiency.

In order to solve the above problem, Korean Utility Model Application No. 1999-12871 discloses a circular saw for cutting the objects to be cut, such as stone and metals. According to the above circular saw, a plurality of the cooling holes 2 are formed symmetrically at upper and lower portions of a disc plate 10 in order to reduce thermal load. However, the circular blade still has the problem derived from heat generations occurred from the cutting tip itself and from friction of the steel shank during the cutting process.

Furthermore, when performing the cutting process with respect to the objects to be cut, like stone, properties of the objects (for example, the quartz content, machinability, the mineral content, or the particle size of the object) may exert serious influence upon the cutting performance of the saw blade. Therefore, not only the chemical composition and the composition ratio of the metal bond which is a component of the segment forming the cutting tip of the saw blade, but also the content of diamond powder mixed with the metal bond may vary depending on hardness of the objects to be cut.

Recently, manufacturers of saw blades have found that it is possible to fabricate segments having various qualities by using various types of metal bonds. However, it is very difficult for the manufactures of the saw blades to find out the best conditions such as time, temperature and pressure during the sintering process for the optimum property of the cutting tip segment forming of the saw blade.

Accordingly, there are great demands for a cutting tip having an improved structure capable of solving the above problem and a saw blade provided with the cutting tip.

### DISCLOSURE OF INVENTION

### Technical Problem

Accordingly, the present invention has been made to solve the above mentioned problems occurring in the prior art, and a first object of the present invention is to provide a cutting tip having an improved structure capable of enhancing the cutting performance by 30% as compared with that of a conventional cutting tip, and a saw blade having the cutting tip.

A second object of the present invention is to provide a cutting tip having an improved structure capable of facilitating initial cutting work without grinding an outer peripheral portion of an object to be cut, and a saw blade having the cutting tip.

A third object of the present invention is to provide a cutting tip having an improved structure and a saw blade having the cutting tip, in which the life time of the saw blade can be expanded by attenuating load applied to the saw blade during the cutting process.

A fourth object of the present invention is to provide a cutting tip having an improved structure suitable for various objects to be cut and a saw blade having the cutting tip, in which the life time of the cutting tip can be controlled by adjusting the content of diamond powder contained in the segment on the basis of hardness of a metal bond, regardless of the chemical composition and composition ratio of the metal bond contained in the segment in order to form the cutting tip.

A fifth object of the present invention is to provide a cutting tip and a saw blade having the cutting tip, in which the cutting tip has an improved structure capable of simplifying the manufacturing process and significantly reducing the manufacturing cost for the saw blade.

A sixth object of the present invention is to provide a cutting tip and a saw blade having the cutting tip, in which the cutting tip has an improved structure capable of representing superior cooling efficiency during the cutting process, so that a body of the saw blade, in particular, a shank of a circular saw blade can be prevented from being broken during the cutting process, thereby ensuring safety of the worker.

### Technical Solution

In order to accomplish the above objects, the present invention provides a cutting tip of a saw blade for cutting various objects such as jewelry, ferrite materials, stone, metallic materials, or ceramic tiles, by having high hardness. And the cutting tip comprises: a mesh pattern formed on upper and lower surfaces of the cutting tip.

According to the preferred embodiment of the present invention, the mesh pattern includes a relief section having a plurality of relief lines, which cross each other at a predetermined angle while forming meshes, and an engraving section defined by the relief lines of the relief section.

The mesh pattern formed on the upper surface of the cutting tip is offset from the mesh pattern formed on the lower surface of the cutting tip.

The relief section of the mesh pattern formed on the upper surface of the cutting tip corresponds to the relief section of the mesh pattern formed on the lower surface of the cutting tip.

A relief line of the mesh pattern has a width of about 0.5 to 3.5 mm.

When the mesh pattern formed on the upper and lower surfaces of the cutting tip has a uniform size, a width of a relief line of the mesh pattern is inversely proportional to a content of diamond powder contained in a segment of the cutting tip.

When a relief line of the mesh pattern formed on the cutting tip has a uniform width, a size of the mesh pattern is proportional to a content of diamond powder contained in a segment of the cutting tip.

The diamond powder includes at least one selected from the group comprising of natural diamond powder, synthetic diamond powder, and cubic boron nitride (CBN).

The content of the diamond powder contained in the segment is proportional to rockwell hardness (HRc) of a metal bond.

The diamond powder contained in the segment has a particle size in a range of about 30 to 120 meshes.

In addition, the present invention also provides a saw blade including the cutting tip having the above structure.

The saw blade includes a body shaped by one selected from the group comprising of a flat type, a disc type, a core-drill type or a grinding cup wheel type.

When the body of the saw blade has a disc shape, a plurality of cooling holes are formed in the disc-shaped body.

When the saw blade is a circular saw blade, a plurality of cooling holes are formed in a body of the circular saw blade.

### ADVANTAGEOUS EFFECTS

The present invention has the following advantages.

First, the cutting tip and the saw blade having the cutting tip according to the present invention represent superior cutting performance as compared with that of the conventional saw blade having the conventional cutting tip.

In addition, the cutting tip and the saw blade having the cutting tip according to the present invention can perform initial cutting without grinding an outer peripheral portion of an object to be cut.

Further, the cutting tip and the saw blade having the cutting tip according to the present invention can expand the life time of the saw blade by attenuating load applied to the saw blade during the cutting process.

Furthermore, the cutting tip and the saw blade having the cutting tip according to the present invention can easily cut various objects and can control the life time of the cutting tip by adjusting the content of diamond powder contained in the segment on the basis of hardness of a metal bond, regardless of the chemical composition and composition ratio of the metal bond contained in the segment.

In addition, the cutting tip and the saw blade having the cutting tip according to the present invention can simplify the manufacturing process and significantly reduce the manufacturing cost for the saw blade.

In addition, the cutting tip and the saw blade having the cutting tip according to the present invention represent superior cooling efficiency during the cutting process, so that a body of the saw blade, in particular, a shank of a circular saw blade can be prevented from being broken during the cutting process, thereby ensuring safety of the worker.

### BRIEF DESCRIPTION OF THE DRAWINGS

FIG. 1 is a front view illustrating a conventional circular saw blade;

FIG. 2 is an enlarged view illustrating a structure of a cutting tip formed in the conventional circular saw blade shown in FIG. 1;

FIG. 3 is a perspective view illustrating a circular saw blade having a cutting tip according to one embodiment of the present invention;

FIG. 4 is an enlarged view of a cutting tip shown in FIG. 3;

FIG. 5 is a perspective view illustrating a circular saw blade having a cutting tip according to another embodiment of the present invention;

FIG. 6 is an enlarged view of a cutting tip shown in FIG. 5;

FIG. 7 is a schematic view illustrating an empty cavity formed in a cutting tip when a cutting process is performed by means of the circular saw blade shown in FIGS. 3 and 5;

FIG. 8 is a view illustrating a moving direction of diamond powder contained in a segment during a sintering process for the segment, which forms a conventional cutting tip;

FIGS. 9 and 10 are views illustrating a moving direction of diamond powder contained in a segment during a sintering process for the segment, which forms a cutting tip according to one embodiment of the present invention;

FIG. 11 is a view illustrating a trail formed by diamond powder, which is contained in a segment according to properties of a metal bond in order to form a conventional cutting tip;

FIG. 12 is a view illustrating a trail formed by diamond powder, which is contained in a segment according to properties of a metal bond in order to form a cutting tip of the present invention;

FIGS. 13 and 14 are views for explaining the reason that causes a limitation of the content of diamond powder in a segment, which forms a conventional cutting tip;

FIG. 15 is a view for explaining the reason that does not cause a limitation of the content of diamond powder in a segment, which forms a cutting tip according to one embodiment of the present invention;

FIGS. 16 and 17 are graphs illustrating the difference of cutting performance and life time between a conventional saw blade having a typical cutting tip and a saw blade having a cutting tip according to one embodiment of the present invention, when an object to be cut is sandstone;

FIGS. 18 and 19 are graphs illustrating the difference of cutting performance and life time between a conventional saw blade having a typical cutting tip and a saw blade having a cutting tip according to one embodiment of the present invention, when an object to be cut is marble; and

FIGS. 20 and 21 are graphs illustrating the difference of cutting performance and life time between a conventional saw blade having a typical cutting tip and a saw blade having a cutting tip according to one embodiment of the present invention, when an object to be cut is granite.

### BEST MODE FOR CARRYING OUT THE INVENTION

Hereinafter, a cutting tip and a saw blade having the cutting tip according to the preferred embodiment of the present invention will be described with reference to accompanying drawings.

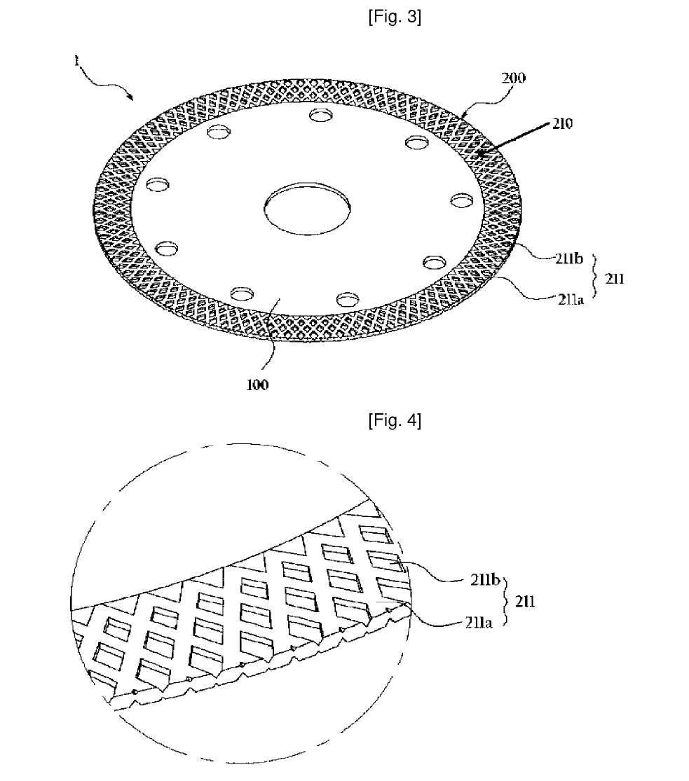

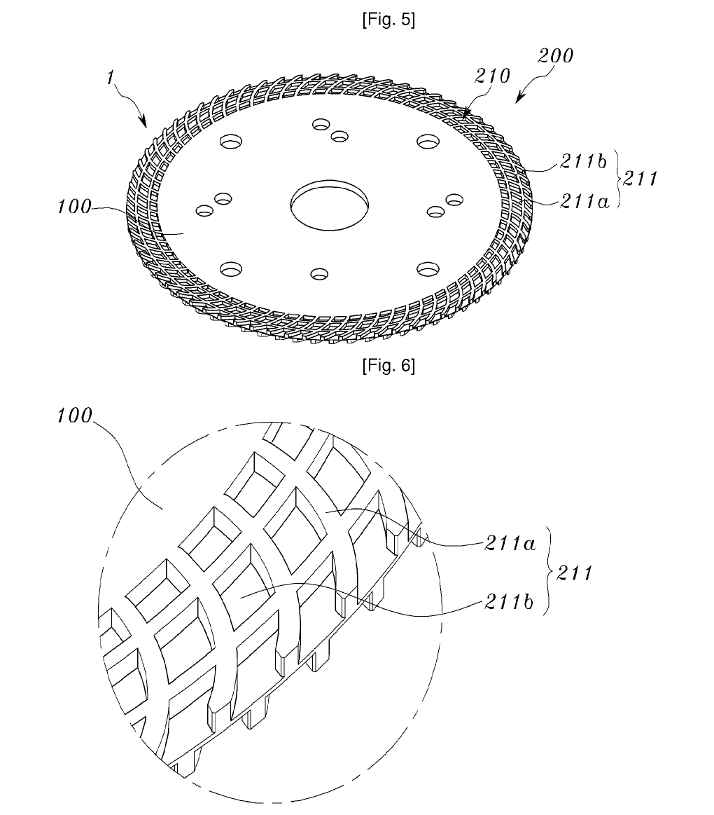

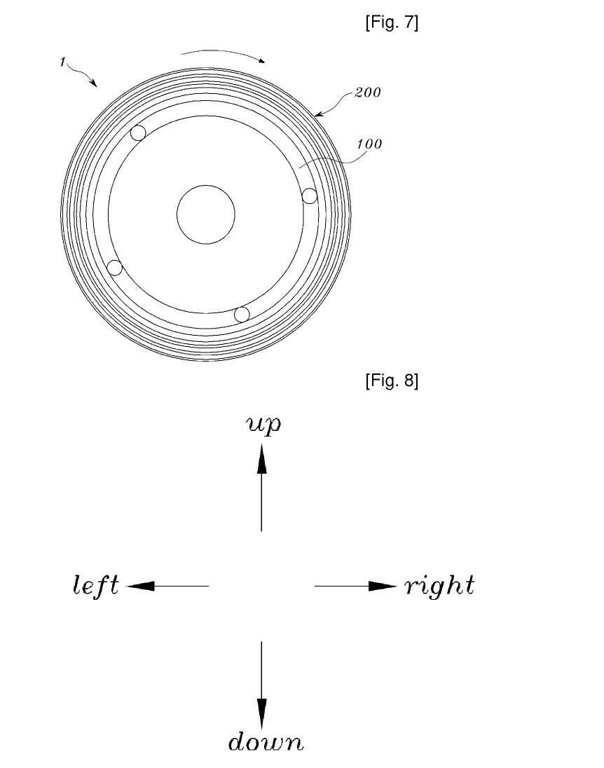

FIG. 3 is a perspective view illustrating a circular saw blade having a cutting tip according to one embodiment of the present invention, FIG. 4 is an enlarged view of the cutting tip shown in FIG. 3, FIG. 5 is a perspective view illustrating a circular saw blade having a cutting tip according to another embodiment of the present invention, FIG. 6 is an enlarged view of the cutting tip shown in FIG. 5, and FIG. 7 is a schematic view illustrating an empty cavity formed in the cutting tip when a cutting process is performed by means of the circular saw blade shown in FIGS. 3 and 5.

FIGS. 3 to 6 show a circular saw blade 1 used for cutting an object, such as a ferrite material, stone, metallic materials or ceramic tiles. Referring to FIGS. 3 to 6, the circular saw blade 1 includes a body 100 and a cutting tip 200 formed at an outer peripheral portion of the body 100. Both upper and lower surfaces of the cutting tip 200 are formed with a mesh pattern 211. Here, the present invention does not limit the shape of the mesh pattern 211 so long as the mesh pattern 211 consists of a relief section having a plurality of relief lines, which cross each other at a predetermined angle while forming meshes, and an engraving section defined by the relief lines of the relief section. At this time, the relief lines may be in the form of straight lines, curved lines or straight-curved lines. In addition, the engraving section can be formed with a lozenge, a circular or an oval shape according to the shape of the relief lines.

The mesh pattern 211 shown in FIGS. 3 and 4 includes a relief section 211a having a plurality of relief straight lines, which cross each other while forming a pre-determined angle therebetween, and an engraving section 211b defined by the relief straight lines in the form of a lozenge shape. In addition, the mesh pattern 211 shown in FIGS. 5 and 6 includes a relief section 211a having a plurality of relief curved lines, which cross each other, and a curved engraving section 211b defined by the relief curved lines. Here, when the engraving section 211b is defined by the relief straight lines, the engraving section 211b has a substantially lozenge shape as shown in FIGS. 3 and 4. Preferably, the lozenge shape of each engraving section 211b gradually expands, as the position of the engraving section 211b is remote from the body 100 of the circular saw blade 1. In addition, preferably, a plurality of lozenge-shaped engraving sections are aligned in a row along the outer peripheral portion of the body 100.

The mesh pattern 211 having the above structure is preferably formed on both upper and lower surfaces of the cutting tip 200. At this time, the mesh pattern 211 formed on the upper surface 210 of the cutting tip 200 may correspond to the mesh pattern 211 formed on the lower surface of the cutting tip 200 or can be offset from the mesh pattern 211 formed on the lower surface of the cutting tip 200. Preferably, when the mesh pattern 211 formed on the upper surface 210 of the cutting tip 200 corresponds to the mesh pattern 211 formed on the lower surface of the cutting tip 200, the relief section of the mesh pattern 211 formed on the upper surface 210 of the cutting tip 200 preferably corresponds to the relief section of the mesh pattern formed on the lower surface of the cutting tip 200 at the end portion of the cutting tip 200.

In addition, when the mesh pattern 211 formed on the upper surface 210 of the cutting tip 200 is offset from the mesh pattern 211 formed on the lower surface of the cutting tip 200, the relief section of the mesh pattern 211 formed on the upper surface 210 of the cutting tip 200 may partially or fully correspond to the engraving section of the mesh pattern formed on the lower surface of the cutting tip 200 at the end portion of the cutting tip 200. More preferably, at least a half area or the whole area of the relief section of the mesh pattern 211 formed on the upper surface 210 of the cutting tip 200 may correspond to that of the engraving section of the mesh pattern formed on the lower surface of the cutting tip 200.

At this time, each relief line, which forms the mesh pattern 211, preferably has a width of about 0.5 to 3.5 mm. If the width of the relief line is less than 0.5 mm, the cutting tip may be easily worn during the cutting process due to friction between the cutting tip and the object to be cut, so that the life time of the saw blade may be shortened. In contrast, if the width of the relief line exceeds 3.5 mm, it is difficult to obtain the cutting tip having a smooth configuration.

Referring to FIG. 7, which shows empty cavities formed in the cutting tip when the cutting process is performed by means of the circular saw blade as shown in FIGS. 3 and 5, when the circular saw blade 1 having the cutting tip 200 formed with the mesh pattern 211 performs the cutting process, a plurality of empty cavities are formed in the cutting tip 200. Heat generated during the cutting process can be effectively cooled due to the empty cavities. Thus, when the circular saw blade 1 having the cutting tip formed at upper and lower surfaces thereof with the mesh pattern is applied to an automatic saw, the performance of the cutting tip can be improved while reducing heat generated during the cutting process. In addition, it is possible to effectively cool heat generated during the cutting process.

As can be understood from the enlarged views of the cutting tip 200 formed in the circular saw blade 1, the cutting tip 200 has an improved structure capable of facilitating initial cutting work for an object, so that it is possible to directly perform the initial cutting work without grinding an outer peripheral portion of an object to be cut.

Hereinafter, description will be made with reference to FIGS. 8 to 15. When the saw blade having the cutting tip structure according to the present invention is used, the cutting performance of the saw blade can be improved and the life time of the saw blade can be expanded. In addition, various saw blades adaptable for various purposes can be fabricated by adjusting the content of diamond powder contained in the segment on the basis of rockwell hardness (HRc) of a metal bond, regardless of other properties of the metal bond contained in the segment in order to form the cutting tip of the saw blade.

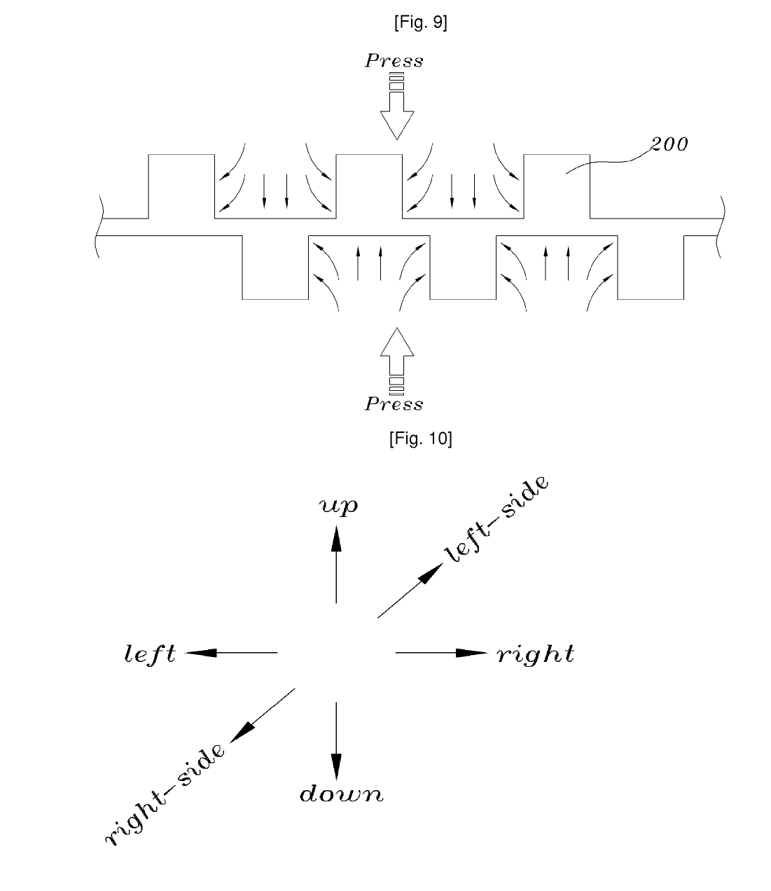

FIG. 8 is a view illustrating the moving direction of diamond powder contained in the segment during the sintering process for the segment, which forms a conventional cutting tip, and FIGS. 9 and 10 are views illustrating the moving direction of diamond powder contained in the segment during the sintering process for the segment, which forms the cutting tip according to one embodiment of the present invention.

As shown in FIG. 8, when the conventional cutting tip is fabricated through the sintering process by applying heat and pressure to the segment, diamond powder contained in the segment may move up, down, left and right directions. However, when the cutting tip according to the present invention as shown in FIG. 9 is fabricated through the sintering process by applying heat and pressure to the segment, diamond powder contained in the segment may move left-sided and right-sided direction in addition to up, down, left and right directions. Thus, diamond powder is concentrated onto the relief lines making contact with the object to be cut, so that the cutting tip may have a structure capable of improving cutting performance thereof.

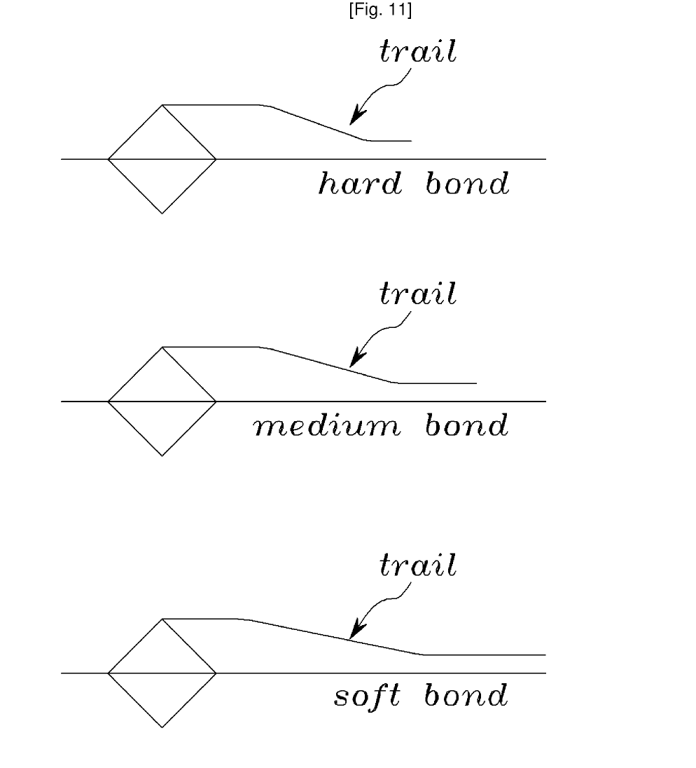

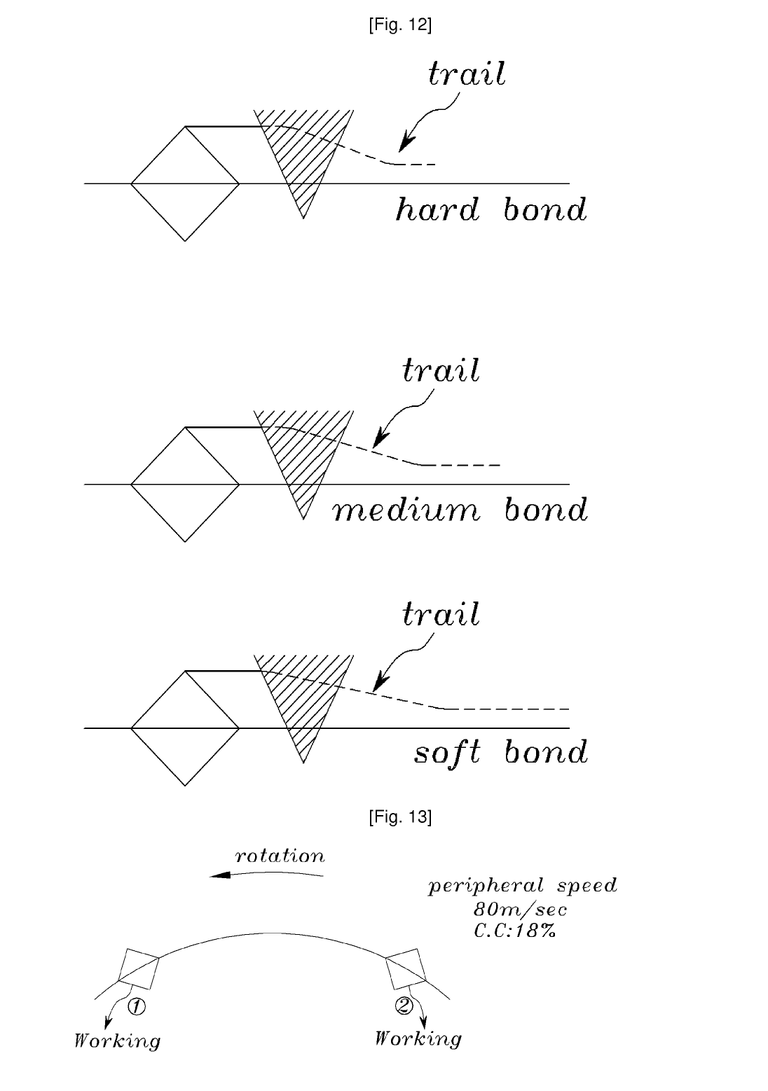

FIG. 11 is a view illustrating a trail formed by diamond powder, which is contained in the segment according to properties of a metal bond (chemical composition and composition ratio of components, additives, etc.) in order to form a conventional cutting tip, and FIG. 12 is a view illustrating a trail formed by diamond powder, which is contained in the segment according to properties of a metal bond in order to form the cutting tip of the present invention.

As shown in FIG. 11, as the hardness of the metal bond contained in the segment of the conventional cutting tip becomes high, the trail formed by the diamond powder is shortened. In contrast, the trail formed by the diamond powder is extended as the hardness of the metal bond contained in the segment of the conventional cutting tip becomes lowered. In general, the properties of the metal bond can be adjusted by manufactures or users depending on several factors, such as the material of the object to be cut, and the life time of the saw blade. If the conventional cutting tip is employed, as shown in FIG. 11, it is necessary to properly adjust the length of the trail formed by the diamond powder, which is contained in the segment according to the properties of the metal bond, in order to obtain desired cutting performance and life time. For this reason, the manufactures must make efforts to adjust the properties of the metal bond. This is because the cutting performance and life time of the cutting tip can be improved only when the properties of the metal bond contained in the segment are optimally harmonious with the material of the object to be cut and the content of the diamond powder.

However, as shown in FIG. 12, according to the cutting tip of the present invention, the trail formed by the diamond powder contained in the segment is forcibly removed. Therefore the content of the diamond powder contained in the segment can be adjusted on the basis of hardness of the metal bond regardless of other properties of the metal bond, so that the saw blade representing superior cutting performance and improved life time can be fabricated according to applications thereof.

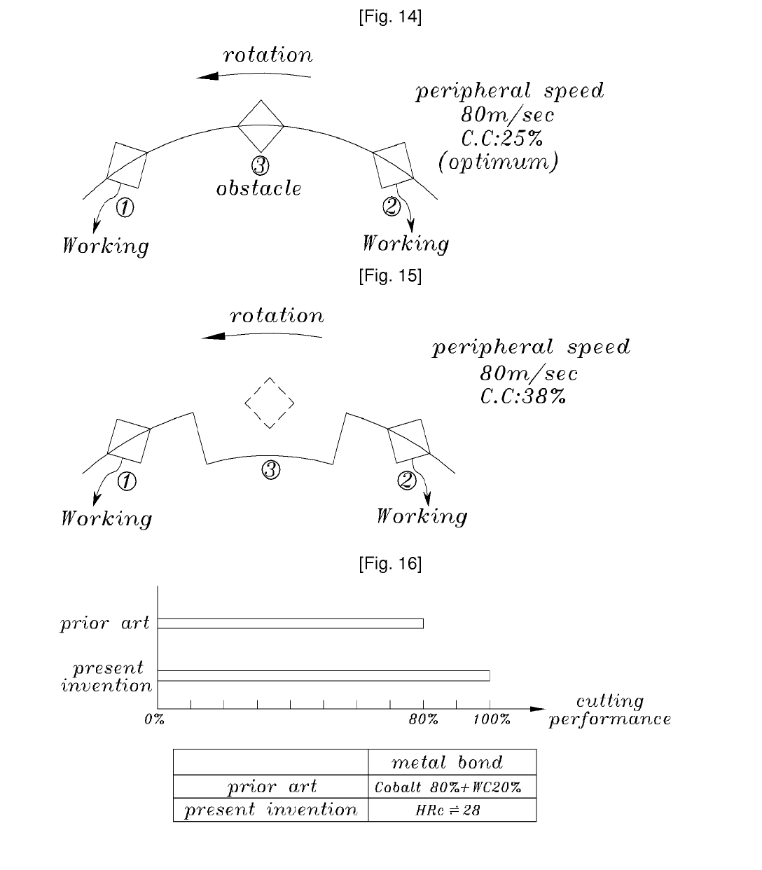

FIGS. 13 and 14 are views for explaining the reason that causes a limitation of the content of diamond powder in the segment, which forms a conventional cutting tip. And FIG. 15 is a view for explaining the reason that does not cause a limitation of the content of diamond powder in the segment, which forms the cutting tip according to the present invention.

As shown in FIG. 13, in the conventional cutting tip, the content of diamond powder is about 18% relative to the metal bond, regardless of the properties of the metal bond. When the conventional cutting tip is fabricated by sintering the segment that includes diamond powder of the above content, a predetermined interval is formed between a first diamond and a second diamond, so that the cutting process can be properly performed due to the predetermined interval.

However, if the content of diamond powder increases so as to improve the cutting performance of the cutting tip, as shown in FIG. 14, a third diamond is interposed between the first diamond and the second diamond, thereby interrupting the cutting process. Accordingly, when fabricating the conventional saw blade having the conventional cutting tip, if the content of diamond powder increases to a level of 18% or more in order to improve the cutting performance and life time of the saw blade, the cutting performance of the saw blade is significantly deteriorated. Thus, it is impossible to improve the cutting performance and life time of the saw blade if the content of diamond powder increases. For this reason, the property of the metal bond is adjusted by adding a material having superior wear-resistance to the metal bond so as to improve the cutting performance and life time of the saw blade.

However, if the saw blade is equipped with the cutting tip according to the present invention, as shown in FIG. 15, the third diamond is not provided between the first and second diamonds even if the content of diamond powder increases proportionally to hardness of the object to be cut, so that it is possible to fabricate the cutting tip while increasing the content of diamond powder by two times as compared with that of the conventional cutting tip. Therefore, according to the cutting tip of the present invention, the cutting performance and wear-resistance of the saw blade can be controlled by adjusting the content of diamond powder, so that it is not necessary to take the chemical composition and composition ratio of the metal bond into consideration based on the material of the object to be cut. In addition, the manufacturing process for the saw blade can be more simplified because the saw blade can be fabricated by simply adjusting the content of diamond powder on the basis of rockwell hardness (HRc) of the metal bond while employing the metal bond having the same property regardless of the material of the object to be cut.

In addition, if the mesh pattern formed on upper and lower surfaces of the cutting tip has a uniform size, preferably, the width of the relief line of the mesh pattern is inversely proportional to the content of diamond powder contained in the segment of the cutting tip. If the width of the relief line becomes enlarged, the cutting tip may be rarely worn by load applied thereto during the cutting process, even if the content of diamond powder decreases. That is, the desired content of diamond powder is assumed as 20% when the relief line of the mesh pattern formed in the cutting tip according to the present invention has the width of 1 mm. In this state, if the width of the relief line is enlarged to 2 mm, the life time of the saw blade may not be shortened even if the content of diamond powder is less than 20%.

At this time, even though the width of the relief line is enlarged to 2 mm, if the interval between relief lines is enlarged, that is, if an area of the engraving section is enlarged as compared with that of the engraving section formed when the relief line has the width of 1 mm, the saw blade can maintain the improved cutting performance and life time even if the content of diamond powder is maintained at 20%. Therefore, when the relief lines of the mesh pattern formed in the cutting tip according to the present invention have the same width, the size of the mesh pattern is proportional to the content of diamond powder contained in the segment of the cutting tip.

In addition, the size of the mesh pattern may vary depending on applications thereof. However, the content of diamond powder for each mesh must be constant in order to obtain the optimum cutting performance. That is, when the content of diamond powder is uniform over the whole area of the cutting tip, the life time of the saw blade may be lengthened as the size of the mesh pattern is enlarged.

Here, the diamond powder contained in the segment of the cutting tip according to the present invention refers to hard abrasives and includes at least one selected from the group comprising of natural diamond powder, synthetic diamond powder, and cubic boron nitride (CBN). A particle size of the diamond powder is preferably 30 to 120 meshes. If the particle size of the diamond powder exceeds 30 meshes or is smaller than 120 meshes, the cutting tip cannot achieve the object and effect of the present invention. For this reason, diamond powder having the particle size of 30 to 120 meshes is contained in the segment of the cutting tip according to the present invention. More preferably, the particle size is increased or decreased in a 5-mesh unit within the above range.

FIGS. 16 to 21 show graphs illustrating the difference of cutting performance and life time between a conventional saw blade having a typical cutting tip and a saw blade having a cutting tip according to one embodiment of the present invention.

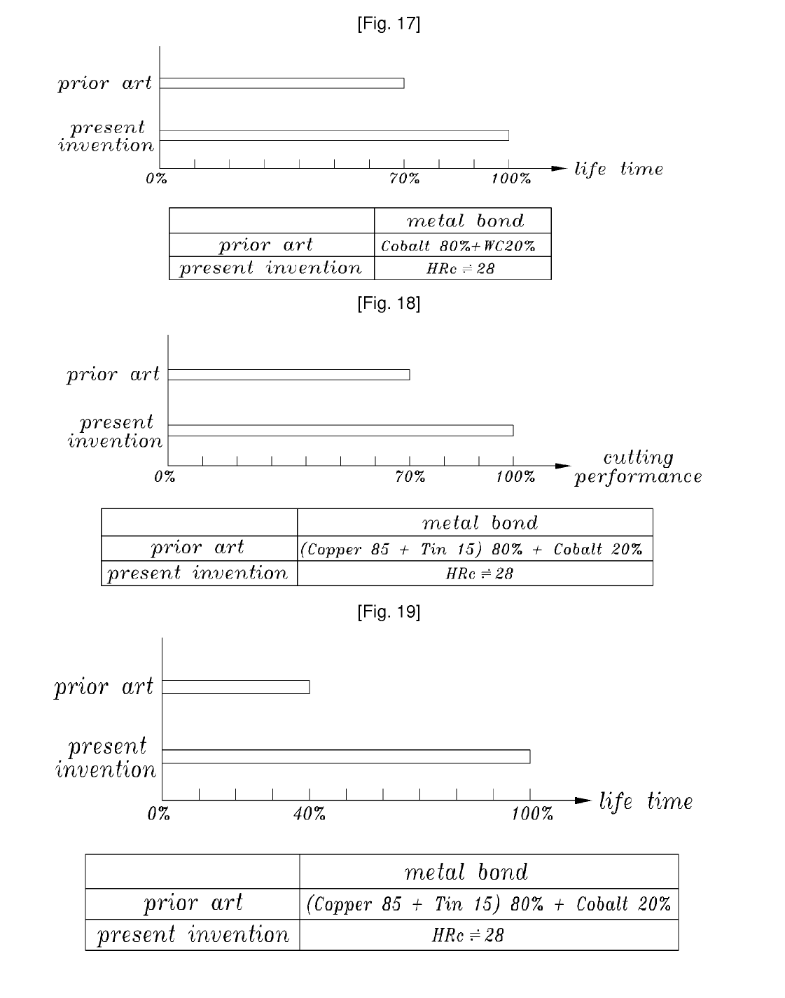

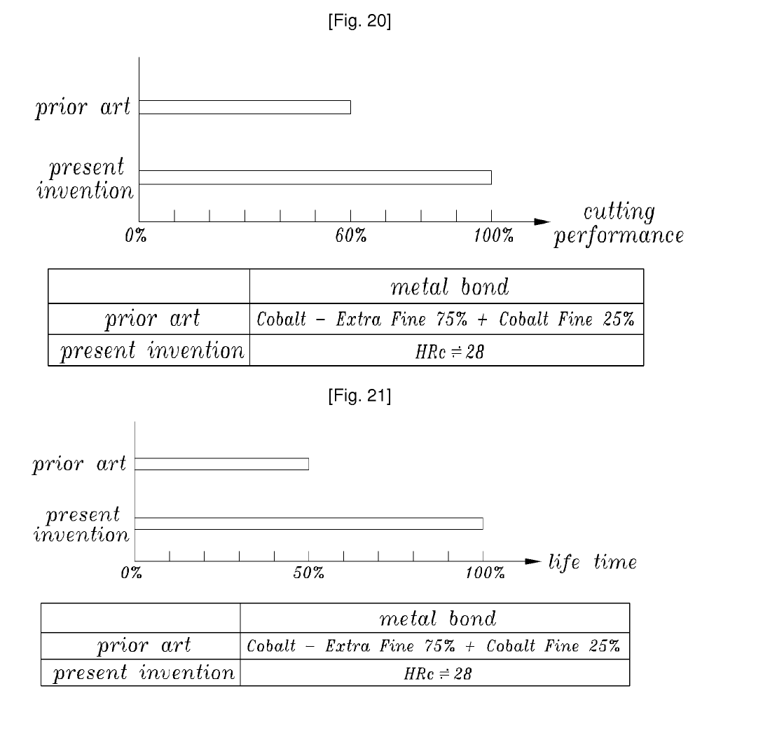

In detail, FIGS. 16 and 17 are graphs illustrating the difference of cutting performance and life time between the conventional saw blade having the typical cutting tip and the saw blade having the cutting tip according to one embodiment of the present invention, when an object to be cut is sandstone. FIGS. 18 and 19 are graphs illustrating the difference of cutting performance and life time between the conventional saw blade having the typical cutting tip and the saw blade having the cutting tip according to one embodiment of the present invention, when the object to be cut is marble. FIGS. 20 and 21 are graphs illustrating the difference of cutting performance and life time between the conventional saw blade having the typical cutting tip and the saw blade having the cutting tip according to one embodiment of the present invention, when the object to be cut is granite.

It can be understood from FIGS. 16 to 21 that the saw blade having the cutting tip according to the present invention represents improved cutting performance and life time as compared with the conventional saw blade having the typical cutting tip. In addition, according to the conventional cutting tip, the chemical composition and composition ratio of the metal bond may vary depending on the material of the object to be cut. However, according to the cutting tip of the present invention, the content of diamond powder is adjusted on the basis of rockwell hardness (HRc 28) of the metal bond, regardless of the material of the object to be cut.

That is, the conventional saw blade is fabricated by taking the chemical composition and composition ratio of the metal bond into consideration, but the saw blade having the cutting tip according to the present invention is fabricated by adjusting the content of diamond powder, so that the manufacturing process for the saw blade can be simplified, and the cutting performance and life time of the saw blade can be improved while ensuring safety during the cutting process.

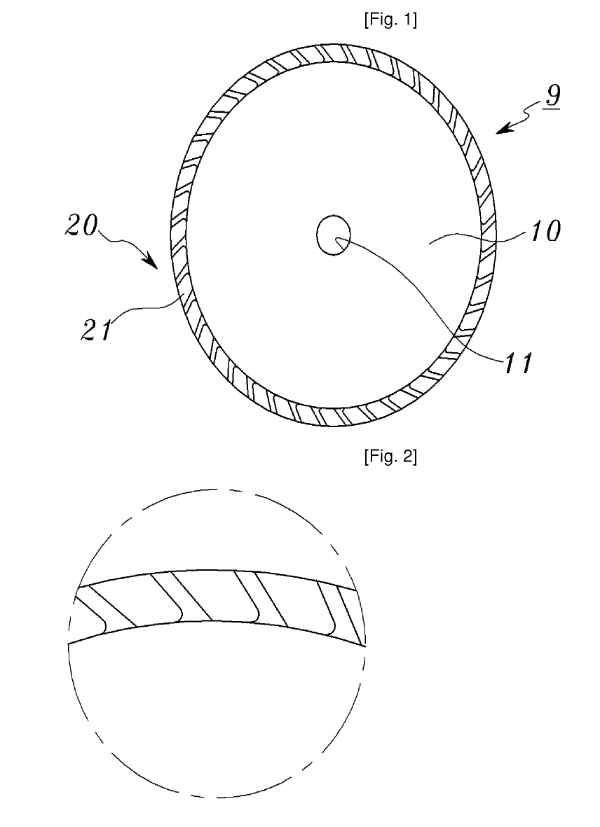

When the cutting tip made from the present invention is applied to the circular saw blade, the frictional heat generation from the cutting tip and the body of the saw blade can be significantly reduced as compared with those of the circular saw blade having the conventional cutting tip as shown in FIG. 1.

In addition, as shown in FIGS. 3 and 5, if the body 100 of the saw blade 1 equipped with the cutting tip according to the present invention has a disc shape, a plurality of cooling holes are preferably formed in the body 100 of the saw blade 1. In this case, air may freely pass through the cooling holes during the cutting process, so that the thermal load applied to the body 100 caused by friction between the object to be cut and the body 100 can be reduced. That is, stability of the body 100 can be improved if the cooling holes are formed in the body 100 of the circular saw blade 1.

Although the description has been prepared in relation to the circular saw blade that having the cutting tip according to the present invention, the cutting tip according to the present invention can also be applied to saw blades having various shapes, like others than the circular shape.

That is, although it is not described in detail, the saw blade may include a body shaped by at least one selected from the group comprising of a flat type, a disc type, a core-drill type, or a grinding cup wheel type etc. The effect of the present invention may not be changed even if the shape of the body of the saw blade having the cutting tip is changed.

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

### INDUSTRIAL APPLICABILITY

As described above, the present invention provides a saw blade capable of cutting various objects, such as jewelry, ferrite materials, stone, ceramic tiles or metallic materials. The shape of the cutting tip of the saw blade is modified such that cutting performance and life time of the saw blade can be improved. And also the manufacturing process for the saw blade can be simplified, thereby reducing the manufacturing cost for the saw blade.

1. A cutting tip of a saw blade for cutting various objects such as jewelry, ferrite materials, stone, metallic materials, or ceramic tiles, the cutting tip comprising:
A mesh pattern formed on upper and lower surfaces of the cutting tip.

2. The cutting tip as claimed in claim 1, wherein the mesh pattern includes a relief section having a plurality of relief lines, which cross each other at a pre-determined angle while forming meshes, and an engraving section defined by the relief lines of the relief section.

3. The cutting tip as claimed in claim 1, wherein the mesh pattern formed on the upper surface of the cutting tip is offset from the mesh pattern formed on the lower surface of the cutting tip.

4. The cutting tip as claimed in claim 2, wherein the relief section of the mesh pattern formed on the upper surface of the cutting tip corresponds to the relief section of the mesh pattern formed on the lower surface of the cutting tip.

5. The cutting tip as claimed in claim 1, wherein a relief line of the mesh pattern has a width of about 0.5 to 3.5 mm.

6. The cutting tip as claimed in claim 1, wherein, when the mesh pattern formed on the upper and lower surfaces of the cutting tip has a uniform size, a width of a relief line of the mesh pattern is inversely proportional to a content of diamond powder contained in a segment of the cutting tip.

7. The cutting tip as claimed in claim 1, wherein, when a relief line of the mesh pattern formed on the cutting tip has a uniform width, a size of the mesh pattern is proportional to a content of diamond powder contained in a segment of the cutting tip.

8. The cutting tip as claimed in claim 6, wherein the diamond powder includes at least one selected from the group comprising of natural diamond powder, synthetic diamond powder, and cubic boron nitride (CBN).

9. The cutting tip as claimed in claim 8, wherein the content of the diamond powder contained in the segment is proportional to rockwell hardness (HRc) of a metal bond.

10. The cutting tip as claimed in claim 8, wherein the diamond powder contained in the segment has the particle size in a range of about 30 to 120 meshes.

11. A saw blade having a cutting tip as claimed in claim 1.

12. The saw blade as claimed in claim 11, wherein the saw blade includes a body shaped by one selected from the group comprising of a flat type, a disc type, a core-drill type or a grinding cup wheel type.

13. The saw blade as claimed in claim 12, wherein, when the body of the saw blade has the disc shape, a plurality of cooling holes are formed in the disc-shaped body.

14. The cutting tip as claimed in claim 7, wherein the diamond powder includes at least one selected from the group comprising of natural diamond powder, synthetic diamond powder, and cubic boron nitride (CBN).
